(19) United States
(12) Patent Application Publication
(10) Pub. No.: US 2008/0164699 A1
(43) Pub. Date: Jul. 10, 2008

(54) Marine Hydroelectric Power Plant

(76) Inventor: Nielson Vieira, Curitiba (BR)

Correspondence Address: DAVID A. GUERRA;INTERNATIONAL PATENT GROUP, LLC, 2025 17TH AVENUE N.W., CALGARY, AB, T2M 0S7, omitted

(21) Appl. No.: 11/911,098

(22) PCT Filed: Jun. 16, 2006
(86) PCT No.: PCT/BR2006/000118

§ 371 Date: Oct. 9, 2007

(30) Foreign Application Priority Data
Jun. 27, 2005 (BR) PI0502395-5

(51) Int. Cl. F03B 13/10

(52) U.S. Cl. 290/54

(57) ABSTRACT

The device based on basic principles of mechanical and hydraulic engineering, entirely built in metal on ground platforms or floating platforms, which function is to transform the mechanical energy from water movements and turbulences in seas, lakes and rivers into electric energy, independently from tides. The power plant system, that transforms mechanical energy into electric energy, uses in its operation floating buoys (1), crowbars (3) fitted on the steady axis (4) hold on the pilaster (5). This format consists on the crow-bars support point connected to the, by knee action, toothed arms (7). The toothed arms function is to give continuity in the movement made by the buoys in its descendent movement. The toothed arms are connected to the ratchets (8), hold on the spinning axis (9), pilaster (10), that is connected to a wheel (15) to give balance in the movement made by the spinning axis (9). And this same spinning axis (9) is connected to a big cogwheel (11) that is connected to a small cogwheel (12) hold on the spinning axis (13), pilaster (19), that is directly connected to the Gear Shift Box of Great Rotation (14), pilaster (20). In the Gear Shift Box of Great Rotation (14) exit there is a spinning axis (16), supported by pilaster (21), directly connected to an Electric Energy Generator. The POWER PLANT is a very simple hydro mechanical system, does not require in its operation the inundation of a huge area to produce electric energy. Neither compromises forests and agricultural areas. In addition, this kind of Power Plant does not affect the biodiversity development.

This present Invention Patent refer to: “MARINE HYDROELECTRIC POWER PLANT”, that is a MECHANISM ABLE TO COLLECT ENERGY FROM THE WATER MOVEMENTS AND TURBULENCES OF SEAS, GREAT LAKES AND GREAT RIVERS. INDEPENDENT FROM TIDES AND WATER WAVES, THE ENERGY CAN BE ACQUIRED BY A SYSTEM OF FLOATING BUOYS, IN GLOBE SHAPE, ATTACHED AT AN EDGE OF A CROWBAR TO CONVERT THE ENERGY FROM WATER SWING AND MOVEMENTS OF ASCENDANT AND DESCENDENT TURBULENCES IN THE WATER OF GREAT LAKES AND GREAT RIVERS, INTO ELECTRIC ENERGY. This is a mechanism that utilizes in its structure a system of FLOATING BUOYS, in GLOBE shape, attached at crowbars that can spin around of an axis hold on pilasters, stated on ground platforms and water platforms or at a floating platform in seas, lakes or rivers. This axis is a POINT OF SUPPORT OF THE CROWBARS, and its function is to manage the water swing and turbulences (ascendant and descendent movements) in the seas, great lakes and great rivers to produce electric energy. And what make the “MARINE POWER PLANT” system work are the DESCENDENTS MOVEMENTS OF THE BUOYS through the WEIGHT OF THE BUOYS, putting in function the SYSTEM independently from tides and water waves, converting the movement and turbulences energy in the water of seas, lakes or rivers into electric energy by the marine power plant system. This happens by the descendents movements of the buoys transmitted to the crowbars, conjugated with toothed arms, that works connected to a system of ratchets attached to a spinning axis, containing a big cogwheel connected to a small cogwheel, all these hold in other spinning axis connected to a GEAR TRANSMISSION BOX OF GREAT ROTATION: velocity, force, neuter. All this system, stated on ground platforms located near seas, lakes or rivers; or stated on floating platforms, at anchor, in the water of seas, lakes or rivers, containing the Gear Shift Box of Great Rotation exit and a spinning axis connected to the input axis of the “ELECTRIC ENERGY GENERATOR”.

How it is known by engineers, experts in the technique of the movements of sea water, for acquiring energy from tide or waves movements to convert it into electric energy, verify that until this present date, there are any system projected that could be used industrial or economically on behalf of human kind.

Therefore, the main objective of this INVENTION is: foresee a device that can be easily built and its practical application brings benefits on behalf of human kind. This device HYDRO MECANIC is very simple, entirely built in metal and its operation do not need the tides and sea wave movements, just need the swing and ascendant and descendent turbulences of sea water, lakes and rivers. Entirely built in metal and its very simple mechanical format that is commonly known by mechanical engineering, the system is made of three units: (3) three buoys, in globe shape, (3) three ratchets and (3) toothed arms. This system in connection to the cogwheel ratchets, one big, other small, attached to spinning axis on pilasters, connected to the GEAR TRANSMISSION BOX OF GREAT ROTATION with function of force, speed and neuter, and in the Gear Shift Box exit, a spinning axis is connected to the ELECTRIC ENERGY GENERATOR cogwheels. This configure a system that is able to take advantage of the main functions of the floating buoys and its connection to the crowbars and toothed arms to the cogwheel system, up to Gear Transmission Box connected to the ELECTRIC ENERGY GENERATOR.

For better understanding of the device system, this present Invention, “MARINE HYDROELECTRIC POWER PLANT”, is a device able to take advantage of the water swing and turbulence in seas, great lakes and great rivers, to convert these movements into electric energy. What will follow in the sequence is a detailed description of the MARINE HYDROELECTRIC POWER PLANT, and in addition is made a reference with the Drawings:

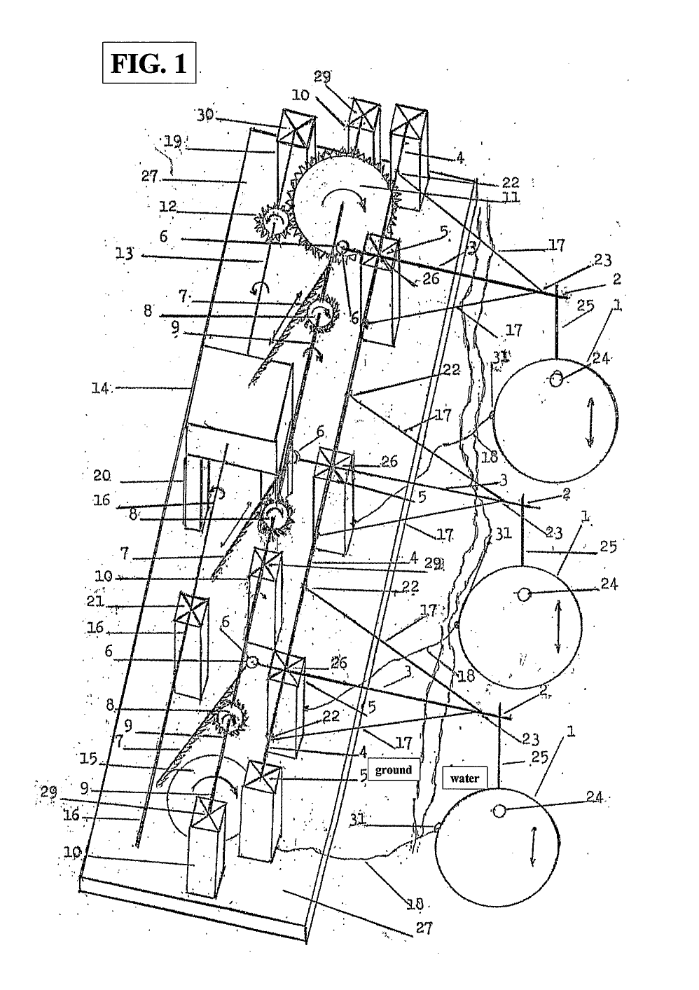

FIG. 1: represents the perspective view, showing the whole parts of the system;

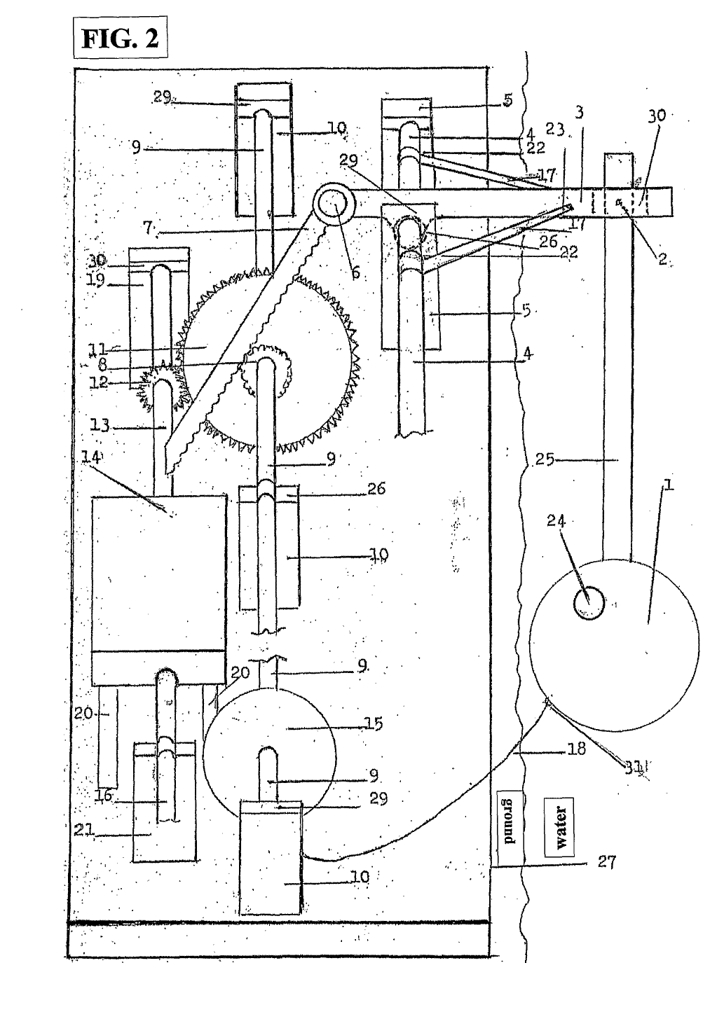

FIG. 2: lateral view, showing the main parts of the system;

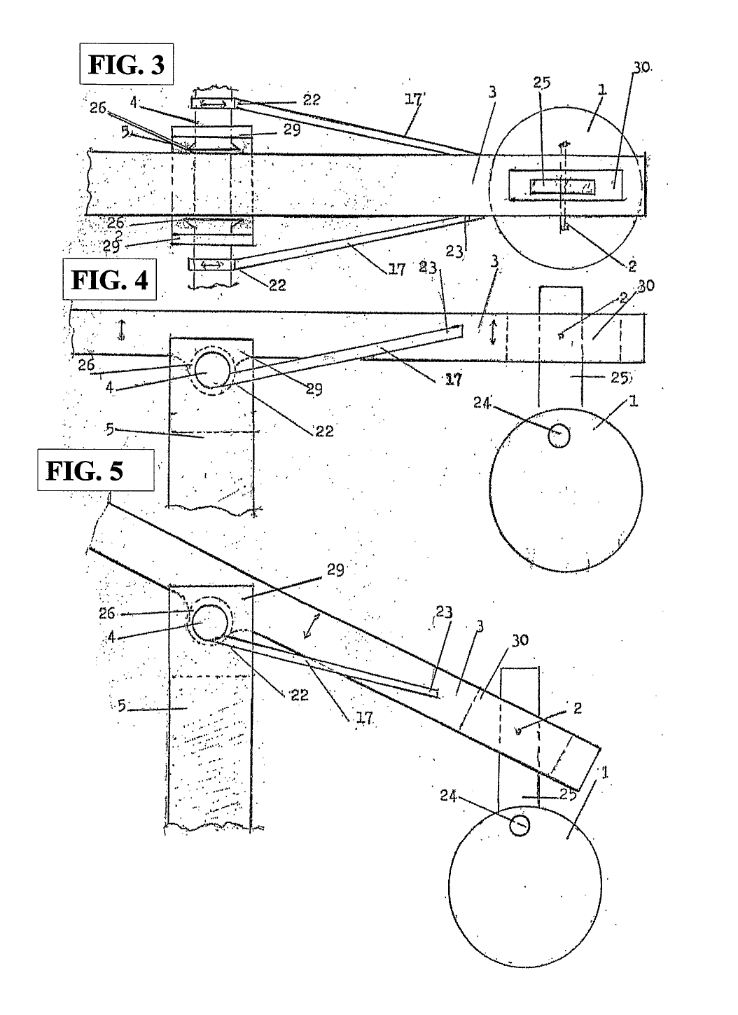

FIG. 3: superior view, support point connected to the crowbars and floating buoys connected to the crowbars;

FIG. 4: lateral view of the crowbars and its highest point in relation with the highest tides and respective water waves, showing the connections of the support points to the crowbars and the connections of the crowbars to the buoys;

FIG. 5: lateral view of the crowbars in the lowest point in relation to the low tides, showing the support point connected to the crowbars and the connections of the buoys to the crowbars. Can be seen that the span where is connected the buoys to the crowbars is for the management of the parts;

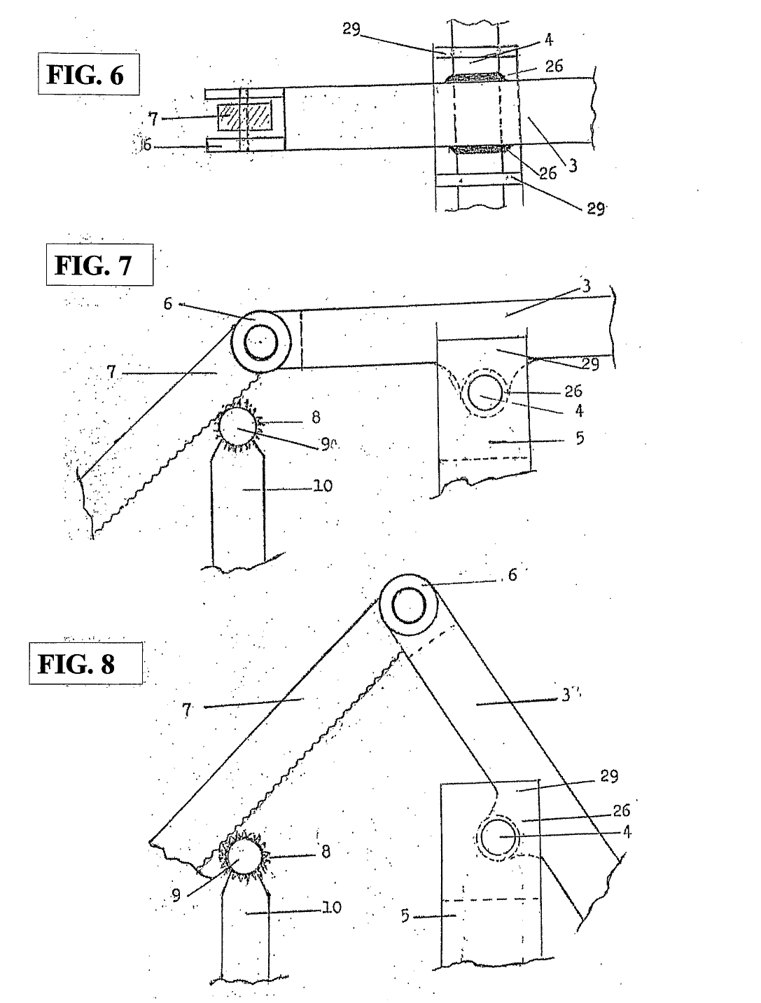

FIG. 6: superior view showing the crowbars connected to the toothed arms and the support point of the crowbars;

FIG. 7: lateral view of the crowbars, on its highest point in relation to the tides and water waves, connected to the point of support, to the toothed arms and to the ratchets;

FIG. 8: lateral view of the crowbars, on its lowest point in relation to the tides, connected to the point of support, to the toothed arms and to the ratchets;

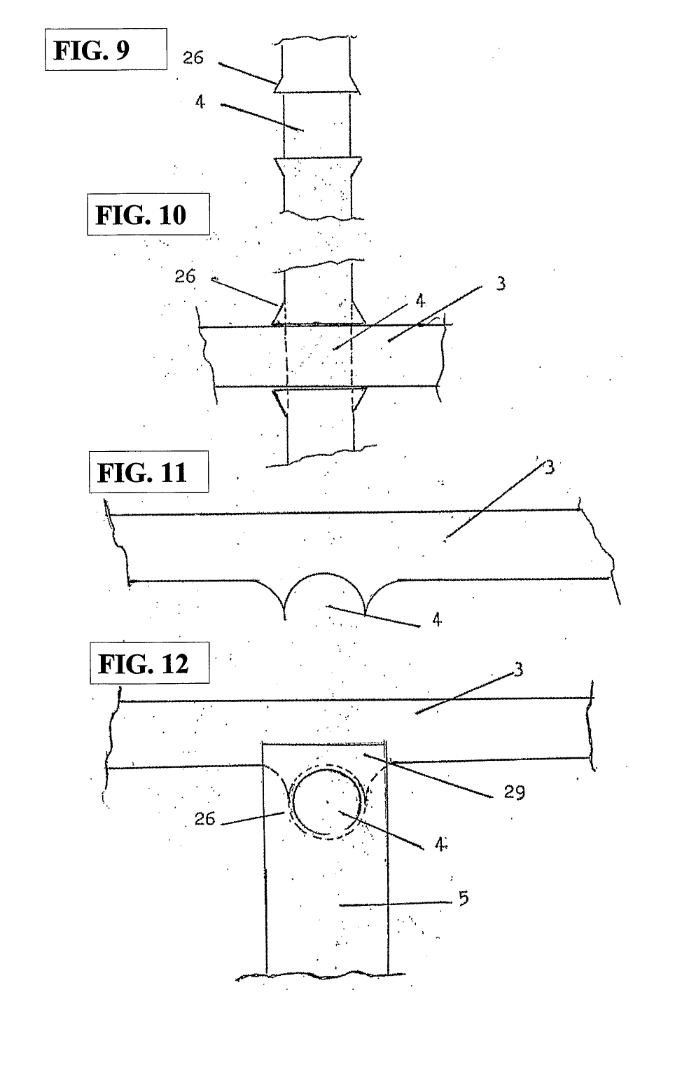

FIG. 9: lateral view showing the steady axis where is located the support point of the crowbars;

FIG. 10: superior view showing the connection of the crowbars to the steady axis, on the support point of the crowbars;

FIG. 11: lateral view of the crowbars in the point of connection to the steady axis, where are located the support points;

FIG. 12: lateral view of the crowbars connected to the steady axis, rightly where is located the support point of the crowbars;

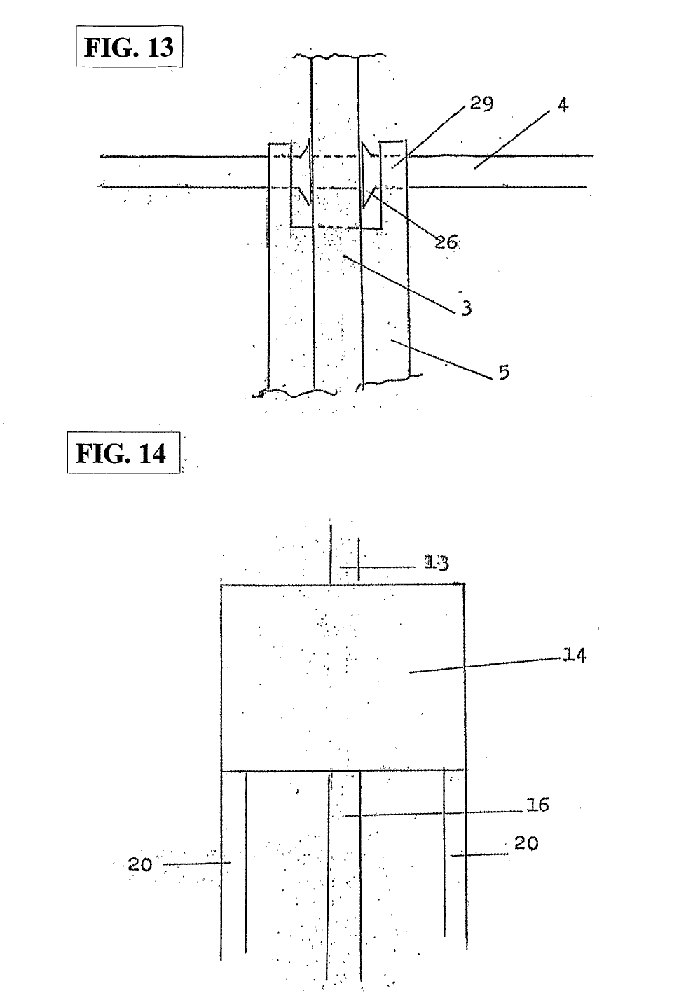

FIG. 13: lateral view, projection of the connection between the crowbars and steady axis and the pilaster, where is located the support point of the crowbars;

FIG. 14: lateral view in projection, showing the Gear Shift Box.

In accord with these FIG. and its details, mainly FIG. 1 to 14, the mechanical arrangement of this Patent of Invention, “MARIE HYDROELECTRIC POWER PLANT”, that it is a device built under mechanical techniques well known by Mechanical Engineering, in association with a system of floating buoys, and that can be placed on seas, lakes or rivers. The main part, corresponding to the cogwheel system, is built on platforms containing the sustentation pilasters that correspond to the crowbars support point connected to the floating buoys. The energy is acquired from water swings and turbulences in seas, lakes and rivers, and these movements keep the device working independently from high or low tides.

The present device is represented on FIG. of INVENTION, and by FIG. 1 is characterized the connections of a Floating Buoys Hydraulic system, and FIG. 2, buoy (1), attached to the arms (25), by knee action at the edge (2) of the crowbars (3), that spin around the steady axis (4), supported by the pilasters (5), where is located the support point (26) of the crowbars (3), and at the edge (6) of the crowbars (3) are connected, by knee action (6), the toothed arms (7) with 45° in relation to the steady axis (4), this format gives a perfect fit with the ratchets (8). By gravity action when the buoys (1) make a descendent movement in the water swings or turbulences and the arms (7) make the ascendant movement that allow the fitting in the ratchets (8) that is hold on a spinning axis (9). Containing in the axis (9), a wheel (15), to give a balance movement for the system supported by a pilaster (10), and in the same axis (9) is the cogwheel (11) that makes a connection to the cogwheel (12), hold on a spinning axis (13), supported by pilaster (19), that is connected to a Gear Transmission Box of Great Rotation (14), supported by pilaster (20). The Gear Transmission Box, already seen in the industrial machinery, contains the force gear, velocity gear and neuter gear. All this system is supported by pilaster (20), that is hold on ground platforms (27). It is possible for this platform to be anchored on seas, lakes and rivers. The Gear Transmission Box exit (14) is connected to a spinning axis (16), supported by pilaster (21), that makes the connection to the Electric Energy Generator. All this system makes the Marine Hydroelectric Power Plant. For the safety of the crowbars (3) will be placed lateral arms (17), able to spin, connected to the steady axis (4), in a triangle format, and the vertices (23) are connected to the crowbar (3) in the point (23). The triangle base is formed by the axis (4) with the function to stop the lateral movements of the crowbars and the buoys; in addition this format allows the buoys to stays in the same position in relation to the steady axis (4).

It will be place on the buoys (1), hermetic windows (24) for maintenance purpose in its interior. The buoys (1) will be connected to the crowbars (3) by the arms (25), and the buoys (1) will be connected to the pilasters (5) by hawser (18) for the buoys not to adrift in case of catastrophe. On the crowbars (3) will be placed a footbridge for maintenance purpose and through this footbridge will be placed electric cables for illumination at the buoys and its beacons.

FIG. 2: is shown the lateral view of the connections among the buoys (1), by the arms (25) and at the crowbars (3), with the crowbars (3) support point connected to the pilaster (5) and lateral arms (17), both connected to the axis (4) at point (22) and (23) with the crowbars (3). In the point (6), crowbars (3) connected, by knee action, to the toothed arms (7) that are connected to the ratchets (8) hold on the spinning axis (9). This is where are connected the big cogwheel (11) and the wheel (15). The spinning axis (9) is on the pilasters (10) and these attached to the platform (27). The cogwheel (11) is connected to a small cogwheel (12). Hold on the spinning axis (13), on the pilasters (19) and the spinning axis (13), is connected the Gear Shift Box input (14). At the Gear Shift Box (14) exit is connected the spinning axis (16) to the Electric Energy Generator.

FIG. 3: is shown the superior view of the buoys (1) connections to the crowbars (3). Connections at the point (2) to the arms (25), where are connected the buoys (1), safety lateral arms (17), all connected to the crowbars (3) at the point (23) and the spinning point (22) and the steady axis (4). This configuration is designed to stop the buoys (1) and the crowbars (3) from moving laterally. At the pilaster (5) is shown the fitting place (26) of the crowbars (3). And at the steady axis (4) and its support (29), is shown the crowbars (3) support point.

FIG. 4: lateral view of the buoys (1) connected to the crowbars (3) by the arms (25), with knee action movement at the point (2). Can be seen the horizontal positioning of the crowbar (3) for the buoys to stay in the highest point of tides and sea waves.

This configuration avoids the water to enter in the Marine Hydroelectric Power Plant systems. In this FIG. can be seen the safety arm (17) and its connections (23), connected to the crowbars (3) and the spinning connection (22) connected to the steady axis (4). It is shown, at the point (26), the crowbars (3) spinning connection, connect to the steady axis (4), where it is located the support point of the crowbars (3), on the pilaster (5) and the pilaster point (29). At the buoys (1) is located a hermetic window (24) to make an access to the buoy (1) interior for maintenance purpose.

FIG. 5: is shown the crowbar (3) inclined position to demonstrate the buoy (1) positioning during the tide lowest point.

FIG. 6: superior view of the crowbars (3), its connections to the point (26) and to the steady axis (4) and point (29) to give safety to the steady axis (4). And at the point (26), crowbars (3) support point, is the connection (6) that by knee action in connected to the toothed arms (7).

FIG. 7: lateral view of the crowbars (3), in horizontal position, to indicate the high tides and sea waves positioning. This configuration avoids the water to enter in the system. At the crowbar (3) edge is the connection (6), that by knee action, is connected to the toothed arm (7), that makes the connection to the ratchet (8), hold on the spinning axis (9), located on the pilaster (10). The spinning axis (9) makes the connection to the Gear Shift Transmission Box.

FIG. 8: lateral view of the crowbars (3), in inclined position and connected to the support point (26), on steady axis (4). At crowbars (3) edges, the connection (6) in knee action with the toothed arms (7), that is connected to the ratchet (8), hold on the spinning axis (9), on the pilaster (10).

FIG. 9: partial view of the crowbars (3) fitting place, at the point (26) of the steady axis (4).

FIG. 10: superior view of the crowbars (3), in place with point (26) of the steady axis (4).

FIG. 11: lateral view of the crowbars (3) fitting curve in the steady axis (4).

FIG. 12: lateral and horizontal view of the crowbars (3), in place with steady axis (4), pilaster (5) support point and point (29).

FIG. 13: view in perspective of the crowbars, in place with steady axis (4), in point (26), leaned on the pilasters (5) and point (29).

FIG. 14: view in perspective of the Gear Shift Box of Great Rotation (14), on the pilasters (20) connected to the spinning axis (13). This is the cogwheel axis (12), at FIG. 2, and the spinning axis (16) exit in direction to the Electric Energy Generator. And for the Marine Hydroelectric Power Plant to work, if necessary, to use a Gutter attached to the building ceiling, where the System is on place, to lift the toothed arms (7), disconnecting them from the ratchets (8), FIG. 2, stopping the system with effect from axis (9). The gutter can be substituted by a hydraulic lift to keep the system working from the initial part that are the floating buoys (1), crowbars (3) and toothed arms (7). If necessary, for the system to stop working disconnect the buoys (1) from the crowbars (3) and provisionally anchoring the buoys (1), at the point (31), where is connected the safety hawser (18) for the buoys not to adrift. And for the safety of the entire Marine Hydroelectric Power Plant System, that it is mainly built in metal, build a net of lightning rods circulating the Plant area. It is highly important to built lights and beacons and to build footbridges on the crowbars (3), FIG. 2, for sailing safety and for maintenance purpose respectively. These are the safety procedures to protect the Marine Hydroelectric Power Plant System. At the end of the Plant System, if the necessary, when the excellent speed to produce electric energy was not reached, will be needed to connect one more section to the spinning axis (16) at the Gear Shift Box of Great Rotation exit, a second cogwheel (11) connected to a second cogwheel (12). All this connected to the spinning axis that follows to the Electric Energy Generator.

1. MARINE HYDROELECTRIC POWER PLANT, based on principles of mechanical and hydraulic engineering, characterized by new segment of grouping system using floating buoys, crowbars, ratchets, cogwheels, wheels, gear shift box of great rotation and connections to the electric energy generator, entirely built in metal, uses the energy from water swings and turbulences in seas, lakes and rivers to acquire electric energy, the system that makes it happen is the floating buoys, FIG. 1, connected to the point (2), with knee action, by the arm (25) attached to the crowbars (3), with support point (5), a pilaster, and connected to the crowbars (3), and these connected to the steady axis (4) and to the point (6), with crowbars knee action, and these connected to the toothed arms (7) that impels the system, connected to the ratchets (8), forming the primary base in the process of acquiring electric energy using floating buoys, these buoys acquire the energy from water swings and turbulences in seas, lakes and rivers, independently from tides, and to complete the Marine Hydroelectric Power Plant Working System, the ratchets (8) are hold on in the spinning axis (9), and this connected to the wheel (15), that helps to balance the spinning axis (9) action, and at the same spinning axis (9) it is hold on a small cogwheel (12) that is connected to the spinning axis (13), and this axis makes the connection directly to the Gear Shift Box of Great Rotation, at the Gear Shift Box of Great Rotation exit is connected the spinning axis (16) that makes the connection to the Electric Energy Generator, these parts make the entirely MARINE HYDROELECTRIC POWER PLANT System.

2. MARINE HYDROELECTRIC POWER PLANT, according to the claim 1, characterized to be a movements energy receptor—energy from the water swings and turbulences in seas, lakes and rivers, all that gives to the System a great capability to acquire energy from a endless way, the System can be easily built in metal, using the basic principle of crowbars and floating buoys that make the Electric Energy Generator to work.

3. MARINE HYDROELECTRIC POWER PLANT, according to the claim 1, characterized by the fact that the System is entirely built in metal and using the basic principle of crowbars (3), FIG. 2, pilaster (5) support point and floating buoys (1) connected to the point (2) by the arms (25), this System uses energetic energy from the water swing and turbulences in seas, lakes and rivers.

4. MARINE HYDROELECTRIC POWER PLANT, according to the claim 1, characterized by the fact that the System is hydro-mechanic system easily built and easily to put on work, this work is based on the strength of the crowbars (3) having attached to its edges floating buoys (1), at the center of the pilaster (5) support point and at the other edge, the small one, the connection 6, connected to the toothed arms (7), these are the energy collector precursor by the buoys (1), that gives continuous motions to the system by the connection to the ratchets (8), hold on the spinning axis (9), where is found the big cogwheel (11), that gives too continuous motions to the system, connected to the small cogwheel (12) hold on the spinning axis (13) leaning in the pilaster (19), this one makes the connection to the Gear Shift Box (14) entry, the spinning axis (13) makes the connections, by the Gear Shift Box (14) exit and spinning axis (16), to the Electric Energy Generator.

5. MARINE HYDROELECTRIC POWER PLANT, according to the claim 1, characterized by the fact the type of crowbars used on the MARNE HYDROELECTRIC POWER PLANT System, are special models for the System, FIGS. 3, 4 and 5, with its main characteristics, can be seen in the FIG. 3 the superior view of the crowbars and its main details, the point (2) where is located the span (30) of the crowbar (3) edge, connected to the arm (25) that makes the connection to the floating buoys, can be seen too the crowbars (3) fitting point, at steady axis (4), where are located the rings (26) that are edging of the steady axis (4), these give stability to the crowbars (3) not to move laterally from the its connection point and from the steady axis (4) support, and from pilaster (5), it is seen the safety lateral arms (17) that make the connection and spin at the steady axis (4), to avoid that the crowbars (3) and the buoys (1) from moving laterally and to give strength to the Marine Hydroelectric Power Plant.

6. MARINE HYDROELECTRIC POWER PLANT, according to the claim 1, characterized by the fact that the system is able of acquiring electric energy from water swings and turbulences in seas, lakes and rivers, can be seen a lateral view, in details in FIG. 4, some main details of the crowbars (3) connected to the floating buoys (1) and the pilaster (5) support point in connection to the steady axis (4), the crowbars are at horizontal position reaching the tides and waves highest level to avoid the water to damage the entire invented system, and in the FIG. 5 can be seen the inclined position of the crowbars at the tides and waves lowest level.

7. MARINE HYDROELECTRIC POWER PLANT, according to the claim 1, characterized by the fact that it is a new System of acquiring electric energy from water swings and turbulences in seas, lakes and rivers, and in the FIG. 6 can be seen, in perspective, the superior view, the details of the crowbars (3) and its edge (6) connection to the toothed arms (7), this configuration allows the System to acquire the movement energy from the buoys (1).

8. MARINE HYDROELECTRIC POWER PLANT, according to the claim 1, characterized by the fact of the crowbars (3) energetic capability, that are in FIG. 7, at horizontal position, representing the crowbars at the tides and waves highest level, it is shown too, the connections to the toothed arms (7) and its connection to the ratchets (8), hold on the spinning axis (9) supported by pilaster (10), where is connected to the spinning axis (9) a wheel (15) that gives continuous motion to the axis (9), and on this axis a cogwheel (11) that connects a small cogwheel, hold on the spinning axis (13), to the Gear Shift Box of Great Rotation, FIG. 2, and on the FIG. 8 can be seen the crowbars at the tides highest level position.

9. MARINE HYDROELECTRIC POWER PLANT, according to the claim 1, characterized by the fact that the system is able of acquiring electric energy from water swings and turbulences in seas, lakes and rivers, can be seen on the FIG. 9 the notch at he steady axis (4) on the space between the borders (6), in the place occupied by the crowbar (3), on FIG. 10, can be seen its fitting place an on the FIG. 11 is shown, laterally, the crowbars (3) fitting shape at the steady axis (4), and on the FIG. 12 can be seen the lateral view, in perspective, the crowbar (3) on its place.

10. MARINE HYDROELECTRIC POWER PLANT, according to the claim 1, characterized by the fact that the system is able of acquiring electric energy from water swings and turbulences in seas, lakes and rivers, contains several mechanical parts and brings innovation by steady axis (4) fitting at the pilaster (5), FIG. 13, where can be seen the pilasters (5) edges (29).

11. MARINE HYDROELECTRIC POWER PLANT, according to the claim 1, characterized by the fact that this is a new hydro-mechanic Invent, contains one Gear Shift Box of Great Rotation (14) that receives the energy of spinning motion from the axis (13), this axis receives motion from the system of buoys (1) and crowbars (3) hold on the pilasters (5) support point, these parts are connected, by a spinning axis (16), to the Gear Shift Box of Great in direction to the Electric Energy Generator.

12. MARINE HYDROELECTRIC POWER PLANT, according to the claim 1, characterized by the fact that this is a hydro-mechanic Invent able of acquiring the mechanical energy from water swings and turbulences in seas, lakes and rivers, built in metal, leaning on pilasters installed on ground platforms (27), FIG. 1, or installed on floating platforms, at anchor, in the water of seas, lakes and rivers suitable for the objective of acquiring electric energy from water swings and turbulences.
